(19) United States
(12) Patent Application Publication
(10) Pub. No.: US 2016/0180301 A1
(43) Pub. Date: Jun. 23, 2016

(54) SIMPLIFYING USER INTERACTION IN COMPUTER-AIDED TRANSACTION PROCESSING SYSTEM

(71) Applicant: Zoltan Nochta, Karlsruhe (DE)

(72) Inventor: Zoltan Nochta, Karlsruhe (DE)

(21) Appl. No.: 14/577,238

(22) Filed: Dec. 19, 2014

(51) Int. Cl. G06Q 20/08; G06Q 20/32

(52) U.S. Cl. CPC G06Q 20/085; G06Q 20/322

(57) ABSTRACT

The present disclosure describes methods, systems, and computer program products for computer-aided transaction processing. One computer-implemented method includes receiving, from a client device, an initiation message to initiate a transaction process; retrieving, at a server, transaction data from a database, wherein the transaction data is saved in the database during a previous transaction process; executing, at the server, a transaction based on the transaction data; obtaining a transaction result of the transaction; and transmitting, to the client device, a response message that indicates the transaction result.

### BACKGROUND

In a computer-aided transaction, a user can provide input data to the processing system to execute the transaction. For example, when a user uses an Automatic Teller Machine (ATM) to conduct a transaction, the user can insert the bank card in the ATM and enter a Personal Identification Number (PIN) to validate the user's credentials. The user can then specify or select the type of the transaction and enter relevant transaction data. For example, if the user intends to retrieve cash, the user can enter the desired amount of money, specify the account from which the money is withdrawn, and specify the number of preferred bank notes (if the feature is supported). In some cases, the user can also confirm these choices. A bank processing system can process the data to execute the transaction. If the transaction is successful, the user can take out the cash.

### SUMMARY

The present disclosure relates to computer-implemented methods, computer-readable media, and computer systems for a transaction processing system. One computer-implemented method for simplifying user interactions in a computer-aided transaction process includes receiving, from a client device, an initiation message to initiate a transaction process; retrieving, at a server, transaction data from a database, wherein the transaction data is saved in the database during a previous transaction process; executing, at the server, a transaction based on the transaction data; obtaining a transaction result of the transaction; and transmitting, to the client device, a response message that indicates the transaction result.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, wherein the initiation message comprises temporal information, and wherein the execution of the transaction is further based on the temporal information.

A second aspect, combinable with any of the previous aspects, wherein data of the transaction is saved in the database.

A third aspect, combinable with any of the previous aspects, wherein the execution of the transaction is performed by a database command, where parameters of the database command comprise the transaction data.

A fourth aspect, combinable with any of the previous aspects, wherein the initiation message is received from a mobile application on a mobile device.

The subject matter described in this specification can be implemented in particular implementations so as to realize one or more of the following advantages. First, the transaction processing system approach described in this specification can simplify the user interactions in the transaction process. Therefore, the user experience of the transaction process can be improved. Second, in some cases, databases used in processing the transaction may be locked during the transaction to maintain data consistency. In these or other cases, simplifying user interaction reduces the locked duration and, therefore, improves the performance of the transaction processing system. Third, the transaction processing system approach described can simplify the operations at the client application that processes the user input and, therefore, reduce the resources used by the client application. Fourth, the transaction processing system described can reduce the information exchange between the client application and the server that processes the transaction and, therefore, reduce the transaction time and increase security protection of the transaction. Other advantages will be apparent to those of ordinary skill in the art.

The details of one or more implementations of the subject matter of this specification are set forth in the accompanying drawings and the description below. Other features, aspects, and advantages of the subject matter will be apparent from the description, the drawings, and/or the claims.

### DESCRIPTION OF DRAWINGS

FIG. 1 is a high-level architecture block diagram illustrating a transaction processing system according to an implementation.

FIG. 2 is a block diagram of an exemplary computer used in a transaction processing system according to an implementation.

FIG. 3 is a flow diagram of a method illustrating a transaction process according to an implementation.

FIG. 4A is an illustration of an example transaction processing UI according to an implementation.

FIG. 4B is an illustration of an example result UI according to an implementation.

Like reference numbers and designations in the various drawings indicate like elements.

### DETAILED DESCRIPTION

The following detailed description is presented to enable any person skilled in the art to make, use, and/or practice the disclosed subject matter, and is provided in the context of one or more particular implementations. Various modifications to the disclosed implementations will be readily apparent to those skilled in the art, and the general principles defined herein may be applied to other implementations and applications without departing from the scope of the disclosure. Thus, the present disclosure is not intended to be limited to the described and/or illustrated implementations but is to be accorded the widest scope consistent with the principles and features disclosed herein.

In a computer-aided transaction processing system, a user can enter the data to complete a transaction. In some cases, a user can conduct similar transactions more than one time. In these or other cases, the user can enter the same data, following the same series of the same screens in the same Graphic User Interface (GUI) while communicating with the same system to perform many identical or similar transactions. For example, in an ATM transaction, the user can enter the desired amount of money, specify the account from which the money is withdrawn, specify the number of preferred bank notes, and confirm these choices for each transaction. Among all of these process steps, the ATM can execute process logic and render appropriate screens, which takes time and consumes resources. In some cases, the user intends to pick the same preferred amount of money (e.g., 100 Euros) and have the same preferences regarding the bank notes (e.g., 3*20 [symbol] +2*10 [symbol] +4*5 [symbol] ) for each transaction but may still enter this information for each transaction.

Other computer-aided transaction processing system can have similar scenarios. For example, in a web-based or a mobile app-based transaction processing system, the users may enter transaction data via multiple screens or tabs according to some process flow to input the required data. In some cases, the transaction processing system may save some transaction data at the client site, e.g., in a cookie. These saved transaction data may provide default values for the user to choose, but the system still may ask the user to confirm these values and/or change these values. In some cases, the transaction processing system may store multiple previous transactions and ask the user to select a particular transaction. The system may then use the transaction data of the selected transaction for the processing of the current transaction. In these or other cases, the user still needs to select or input some transaction data related to the current transaction, e.g., pick the particular previous transaction to duplicate. In some cases, the transaction data related to the current transaction is transmitted from the client to the server that processes the current transaction.

In some implementations, the computer-aided transaction can be performed by a transaction processing system. In some cases, the transaction process system can perform the transaction by accessing one or more databases and manipulate the databases based on the transaction information. In some implementations, a relevant database can be locked when the database is first accessed during the transaction. The database may be locked until the transaction is completed in order to maintain data consistency. In the some cases, the locked duration may increase if the time to complete the transaction increases due to delay caused by multiple user interactions. In these or other cases, the database cannot perform other transactions and, therefore, the performance of the transaction process system can be affected.

In some implementations, a transaction processing system can reduce user interactions and, therefore, improve the performance of the system. For example, the transaction data of the last transactions can be stored, and the user can perform the transaction by only issuing a transaction command without entering any transaction data. For example, to retrieve cash from the ATM, the ATM operator can store the transaction information of the latest user interaction (in the above example, “Please hand out 3*20 [symbol] +2*10 [symbol] +4*5 [symbol] ”) that has been performed previously. Once the user logs in to the ATM with the banking card and PIN at some of the operator's own or at one of its partners' ATMs, the machine may display an icon on its touch screen, or a reset button, that indicates “same as last time” (SALT). The user can just touch the icon, or press the button, and get the money without entering or selecting any information relating to the current transaction.

These techniques can be can be applied in other computer-aided transaction processing systems. For example, these techniques may be useful for mobile users with small displays and for people often repeating tasks. In some cases, they can hit one button to initiate the transaction, without entering or selecting any information for the transaction. For example, a user can use a mobile application to claim travel expenses. The user may have multiple trips that are identical, e.g., every day of the week during a customer project or training. The user may take the same bus line to go from the same station nearest to the user's home to the same destination and back. The user may pay the same amount of money every day. On the first relevant day, the user can enter all the data to specify the first travel cost claiming request. From the second day on, the user can just touch the button “same as last time” without entering any other transaction data, selecting from any of the multiple previous transactions, or confirming any information. The system can automatically create and store a new travel item with the same expense data as last time. In some cases, the user can optionally enter temporal information, e.g., the date of the trip, before sending the claim. For example, the user can be asked to specify a date on the initial screen before hitting the “same as last time” button. In some cases, the transaction processing system can automatically determine the temporal information without user input. For example, the transaction process system can determine the date of travel based on the time that command is received from the mobile application. In another example, the mobile application can include the temporal information when the button is pressed in the command that the mobile application sends to the processing server. The processing server can determine the date based on the temporal information in the command.

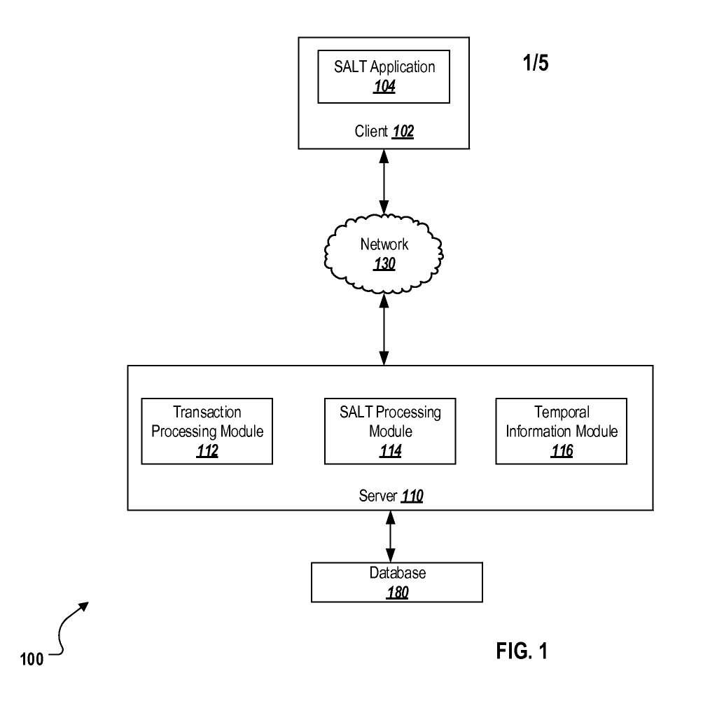

FIG. 1 is a high-level architecture block diagram illustrating a transaction processing system 100 according to an implementation. At a high level, the illustrated system 100 includes a client 102 that is communicably coupled with a server 110 through a network 130. The illustrated system 100 also includes a database 180. The described illustration is only one possible implementation of the described subject matter and is not intended to limit the disclosure to the single described implementation. Those of ordinary skill in the art will appreciate the fact that the described components can be connected, combined, and/or used in alternative ways consistent with this disclosure.

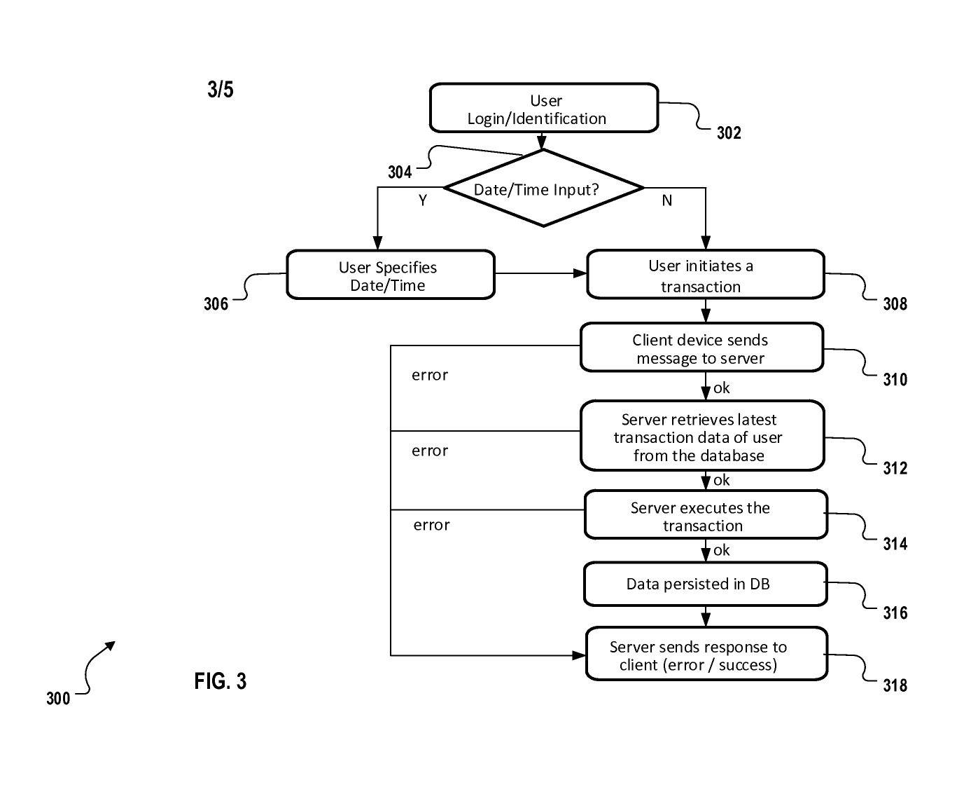

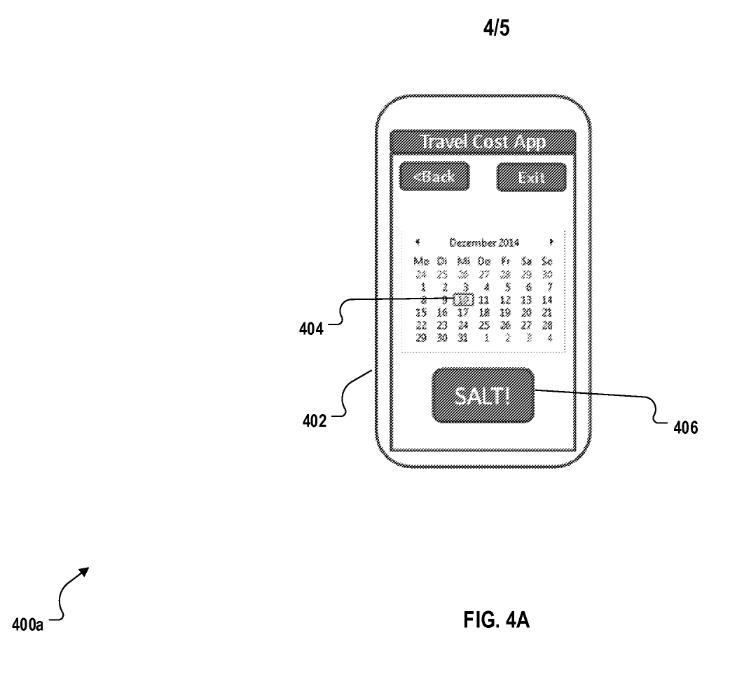

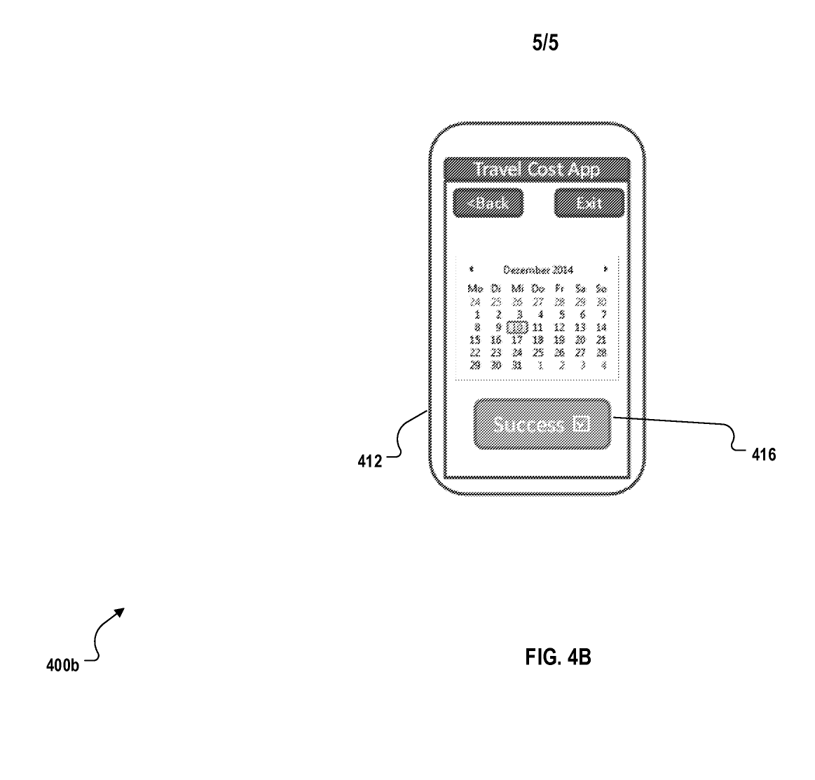

The client 102 represents an application, set of applications, software, software modules, hardware, or combination thereof that can be used to initiate the transaction. Examples of the client 102 can include a computer, a mobile phone, a tablet, an ATM machine, a vending machine, a ticket automaton, or any other client device that interacts with a user in a transaction process. As illustrated, the client 102 includes a “same as last time” (SALT) application 104. The SALT application 104 represents an application, set of applications, software, software modules, hardware, or combination thereof that can be used to provide UIs to a user and communicate with the server 110 in a transaction process. For example, the SALT application 104 can receive user input, generate an initiation message, send the initiation message to the server 110, receive a transaction result from the server 110, and display the transaction result to the user. FIGS. 3-4 and associated descriptions provide additional details of these implementations.

As illustrated, the server 110 represents an application, set of applications, software, software modules, hardware, or combination thereof that can execute the transaction. As illustrated, the server 110 includes a transaction processing module 112, a SALT processing module 114, and a temporal information module 116.

The transaction processing module 112 represents an application, set of applications, software, software modules, hardware, or combination thereof that can communicate with the client 102. For example, the transaction processing module 112 can receive the initiation message sent from the client 102 and transmit the transaction result to the client 102. FIGS. 3-4 and associated descriptions provide additional details of these implementations.

The SALT processing module 114 represents an application, set of applications, software, software modules, hardware, or combination thereof that can execute a transaction. For example, the SALT processing module 114 can interact with the database 180 to retrieve transaction data from the previous transaction and to issue transaction commands to execute the current transaction. FIGS. 3-4 and associated descriptions provide additional details of these implementations.

The temporal information module 116 represents an application, set of applications, software, software modules, hardware, or combination thereof that can process temporal information. For example, the temporal information module 116 can process the temporal information sent in the initiation message, provide the temporal information to the SALT processing module 114, and/or replace old temporal information in the previous transaction. FIGS. 3-4 and associated descriptions provide additional details of these implementations.

The database 180 represents software, software modules, hardware, or combination thereof that can be used to store transaction data. For example, the database 180 can be an object-oriented database, a relational database, or any other databases that save transaction data. In some cases, the database 180 can be located in the server 110. Alternatively or in combination, the database 180 can be located in a database server that is communicably coupled with the server 110.

The network 130 facilitates communications between the components of the system 100 (e.g., between the client 102 and the server 110). In some implementations, the network 130 can be a wireless or a wireline network. In some implementations, the network 130 can also be a memory pipe, a hardware connection, or any internal or external communication paths between the components.

While portions of the software elements illustrated in FIG. 1 are shown as individual modules that implement the various features and functionality through various objects, methods, or other processes, the software can instead include a number of sub-modules, third-party services, components, libraries, and the like, as appropriate. Conversely, the features and functionality of various components can be combined into single components as appropriate.

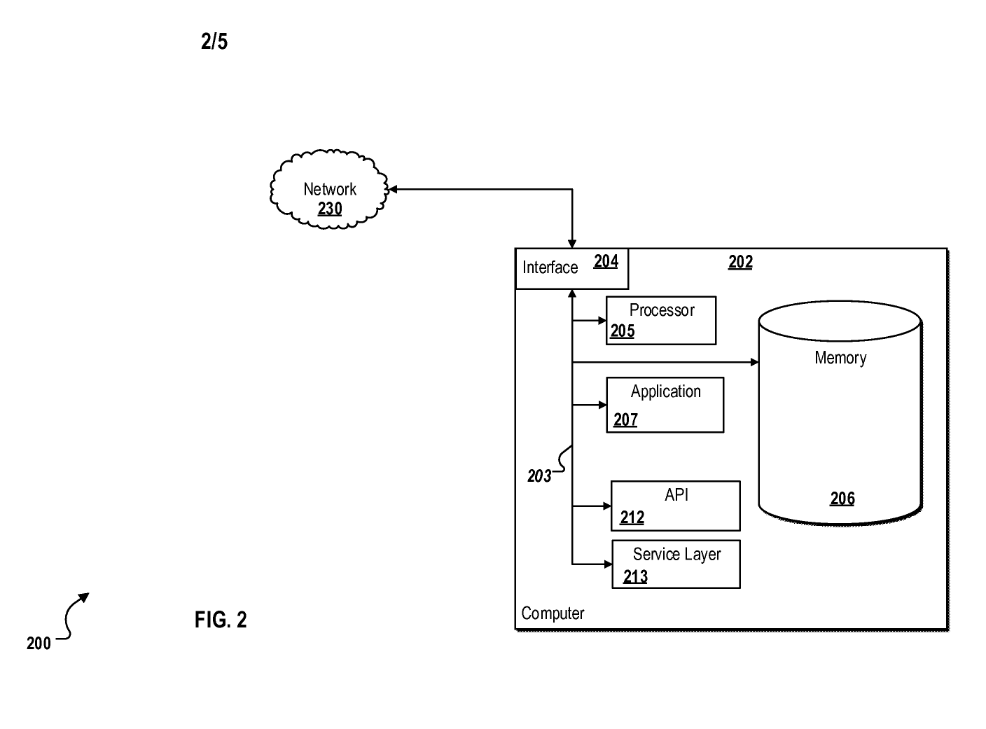

FIG. 2 is a block diagram 200 of an exemplary computer used in a transaction processing system according to an implementation. The illustrated computer 202 is intended to encompass any computing device such as a server, desktop computer, laptop/notebook computer, wireless data port, smart phone, personal data assistant (PDA), tablet computing device, one or more processors within these devices, and/or any other suitable processing device, including both physical and/or virtual instances of the computing device. Additionally, the computer 202 may comprise a computer that includes an input device, such as a keypad, keyboard, touch screen, microphone, speech recognition device, other device that can accept user information, and/or an output device that conveys information associated with the operation of the computer 202, including digital data, visual and/or audio information, or a GUI.

The computer 202 can serve as a client, network component, a server, a database or other persistency, and/or any other component of the system 100. The illustrated computer 202 is communicably coupled with a network 230. In some implementations, one or more components of the computer 202 may be configured to operate within a cloud-computing-based environment.

At a high level, the computer 202 is an electronic computing device operable to receive, transmit, process, store, or manage data and information associated with the system 100. According to some implementations, the computer 202 may also include or be communicably coupled with an application server, e-mail server, web server, caching server, streaming data server, business intelligence (BI) server, and/or other server.

The computer 202 can receive requests over network 230 from a client application (e.g., executing on another computer 202) and respond to the received requests by processing the said requests in an appropriate software application. In addition, requests may also be sent to the computer 202 from internal users (e.g., from a command console or by another appropriate access method), external or third parties, other automated applications, as well as any other appropriate entities, individuals, systems, or computers.

Each of the components of the computer 202 can communicate using a system bus 203. In some implementations, any and/or all the components of the computer 202, both hardware and/or software, may interface with each other and/or the interface 204 over the system bus 203 using an application programming interface (API) 212 and/or a service layer 213. The API 212 may include specifications for routines, data structures, and object classes. The API 212 may be either computer language-independent or -dependent and refer to a complete interface, a single function, or even a set of APIs. The service layer 213 provides software services to the computer 202 and/or the system 100. The functionality of the computer 202 may be accessible for all service consumers using this service layer. Software services, such as those provided by the service layer 213, provide reusable, defined business functionalities through a defined interface. For example, the interface may be software written in JAVA, C++, or other suitable language providing data in Extensible Markup Language (XML) format or other suitable format. While illustrated as an integrated component of the computer 202, alternative implementations may illustrate the API 212 and/or the service layer 213 as stand-alone components in relation to other components of the computer 202 and/or system 100. Moreover, any or all parts of the API 212 and/or the service layer 213 may be implemented as child or sub-modules of another software module, enterprise application, or hardware module without departing from the scope of this disclosure.

The computer 202 includes an interface 204. Although illustrated as a single interface 204 in FIG. 2, two or more interfaces 204 may be used according to particular needs, desires, or particular implementations of the computer 202 and/or system 100. The interface 204 is used by the computer 202 for communicating with other systems in a distributed environment—including within the system 100—connected to the network 230 (whether illustrated or not). Generally, the interface 204 comprises logic encoded in software and/or hardware in a suitable combination and operable to communicate with the network 230. More specifically, the interface 204 may comprise software supporting one or more communication protocols associated with communications such that the network 230 or interface's hardware is operable to communicate physical signals within and outside of the illustrated system 100.

The computer 202 includes a processor 205. Although illustrated as a single processor 205 in FIG. 2, two or more processors may be used according to particular needs, desires, or particular implementations of the computer 202 and/or the system 100. Generally, the processor 205 executes instructions and manipulates data to perform the operations of the computer 202. Specifically, the processor 205 executes the functionality required for transaction processing.

The computer 202 also includes a memory 206 that holds data for the computer 202 and/or other components of the system 100. Although illustrated as a single memory 206 in FIG. 2, two or more memories may be used according to particular needs, desires, or particular implementations of the computer 202 and/or the system 100. While memory 206 is illustrated as an integral component of the computer 202, in alternative implementations, memory 206 can be external to the computer 202 and/or the system 100.

The application 207 is an algorithmic software engine providing functionality according to particular needs, desires, or particular implementations of the computer 202 and/or the system 100, particularly with respect to functionality required for transaction processing. For example, application 207 can serve as one or more components/applications described in FIGS. 1-3. Further, although illustrated as a single application 207, the application 207 may be implemented as multiple applications 207 on the computer 202. In addition, although illustrated as integral to the computer 202, in alternative implementations, the application 207 can be external to the computer 202 and/or the system 100.

There may be any number of computers 202 associated with, or external to, the system 100 and communicating over network 230. Further, the terms “client,” “user,” and other appropriate terminology may be used interchangeably as appropriate without departing from the scope of this disclosure. Moreover, this disclosure contemplates that many users may use one computer 202, or that one user may use multiple computers 202.

FIG. 3 is a flow diagram of a method 300 illustrating a transaction process according to an implementation. For clarity of presentation, the description that follows generally describes method 300 in the context of FIGS. 1-2 and 4. However, it will be understood that method 300 may be performed, for example, by any other suitable system, environment, software, and hardware, or a combination of systems, environments, software, and hardware as appropriate. In some implementations, various steps of method 300 can be run in parallel, in combination, in loops, and/or in any order.

At 302, the user can log in to the transaction processing system with the user credentials. For example, in an ATM process, the user can use the banking card and PIN to log in to the system. In a web-based or mobile application-based system, the user can use a username and associated password to log in to the system. Other methods of inputting and verifying credentials, e.g., Radio Frequency Identification (RFID), Near Field Communication (NFC), fingerprint matching, and voice recognition, can also be used. In some cases, step 302 can be skipped. For example, in a mobile application-based system, the user can launch the mobile application to log in to the system without further entering any login information. In these or other cases, the mobile application can save the user credentials and log in to the system automatically after the application is launched. From 302, method 300 proceeds to 304.

At 304, whether a temporal information input is needed can be determined. In some cases, the temporal information can include at least one date or time of the transaction. In some cases, e.g., in a travel claiming application, the date of the travel might be needed. If the temporal information input is needed, method 300 proceeds from 304 to 306. At 306, the user can specify the temporal information for the transaction. From 306, method 30 proceeds to 308.

If the temporal information input is not needed, method 300 proceeds from 304 to 308. In some cases, the temporal information input might not be needed because the transaction can be processed without the input. For example, the user does not need to input a date/time when retrieving money at an ATM. In some cases, the system can determine the temporal information automatically without user input. For example, the mobile application can send the temporal information of the time the user launches the application or the time the user initiates the transaction to the server. In another example, the server can determine the temporal information based on the time that the transaction initiation message is received from the client.

At 308, the user can initiate the transaction at the client site. In some implementations, the user can initiate the transaction by interacting with a UI at the client device. The UI can be clickable or a touchable icon in a screen or a speech command. The UI can also be a part of the hardware equipment, e.g., a physical button to push placed on vending machines, ticket automatons, ATM, or any other client interactive device. In some implementations, the UI, e.g., the icon or the button, can indicate that the transaction is initiated using transaction data that are the same as the previous transaction. For example, the icon or the button can display a SALT command that stands for “same as last time.” FIG. 4A provides an example of the UI that initiates a transaction. From 308, method 300 proceeds to 310.

At 310, the client device, e.g., the mobile phone or the ATM, sends an initiation message to the server to initiate the transaction. The initiation message can be communicated over any communication channels between the client device and the server. In some cases, the initiation message can be sent via a remote procedure call web service invocation such as a Hypertext Transfer Protocol (HTTP) POST message. The initiation message can indicate to the server that the transaction data of the latest transaction can be used for the current transaction. In some cases, the initiation message can also indicate the user who initiates the transaction. In some implementations, the initiation message does not include any transaction data that is based on information inputted by the user during the current transaction. In some implementations, the initiation message can include the temporal information based on the user input at step 306 but no other transaction data that is based on information inputted by the user during the current transaction. In some cases, there could be an error in the transmission of the initiation message. For example, there may be a communication link failure between the client device and the server. In these cases, method 300 proceeds from 310 to 318. If there is no error in the transmission of the initiation message, method 300 proceeds from 310 to 312.

At 312, the server can receive the initiation message. The server can retrieve the latest transaction data from the database. In some implementations, the server can retrieve the data by using a query to the database. In some cases, the server can also indicate the temporal information and/or the identity of the user in the query. The format of the query can depend on the database model (e.g., relational, object-oriented, etc.), the query language (e.g., Structured Query Language (SQL), procedural language), the schema of the database (e.g., table definitions), and the values in the tables. In some cases, e.g., if the database is a relational database and corresponding transaction data are stored in database tables, the server can launch a Structured Query Language (SQL) query against the tables. The following represents an example of the SQL query:

SELECT fname, lname, from-country, from-city, dest-country, dest-city, amount, currency, meansoftransport, reason_for_trip, MAX(travel-date) AS latest-travel

FROM Travel_Claims

WHERE fname=‘Joe’ AND lname=‘Doe’

GROUP BY fname, lname;

For user “Joe Doe,” the above query may return the dataset to Joe's last entered trip, e.g., the trip he entered on the previous day, following the database table schema. The following represents an example of the data fields:

{fname=Joe, lname=Doe, from-country=Germany, from-city=Karlsruhe, dest-country=Germany, dest-city=Walldorf, amount=7.50, currency=Euro, travel-date=2014-09-12, meansoftransport=Train, reason_for_trip=Daily project meeting}.

In some cases, the query can return errors, which indicate that the data is not successfully retrieved. In these cases, method 300 proceeds from 312 to 318. If the query is successful, method 300 proceeds from 312 to 314. At 314, the server can execute a new transaction based on the retrieved transaction data. In some cases, the execution can be performed by a transactional command to the database. In some cases, the server can include the transaction data retrieved at 312 in the transactional command. In some cases, the server can also include the received temporal information received with the initiation message in the transactional command. In some cases, the server can remove the old temporal information from the transaction data retrieved at 312, replace it with the new temporal information, and include the new temporal information in the transactional command.

In some cases, e.g., in a relational database, the execution can be performed by an SQL command to insert a new row into the respective table. The following represents an example of the SQL command:

INSERT INTO Travel_Claims VALUES (Joe, Doe, Germany, Karlsruhe, Germany, Walldorf, 7.50, Euro, 2014-10-12, Train, Daily project meeting).

In some cases, the transactional command can be an UPDATE or DELETE command instead of an INSERT command.

In some implementations, a client device can store the previous transaction data. When the user initiates a “same as last time” operation, the client device can retrieve the stored transaction data and execute the next transaction, e.g., by sending an SQL INSERT command directly to the database.

In some cases, the transactional command can return errors, which indicate that the transaction is not successfully executed. In these cases, method 300 proceeds from 314 to 318. If the execution is successful, method 300 proceeds from 314 to 316. At 316, the data of the new transaction can be stored in the database. The new transaction can become the latest transaction by the user, and the transaction data of the new transaction can be retrieved the next time the user initiates a “same as last time” transaction. From 316, method 300 proceeds to 318.

At 318, the server can send a response to the client device. The response can indicate the result of the transaction, e.g., whether the transaction is successful. In some cases, the client device can display the result of the transaction in the UI at the client site. FIG. 4B provides an example of the UI that indicates the transaction results.

FIG. 4A is an illustration of an example transaction processing UI 400a according to an implementation. The UI 400a is in a configuration as an initiation UI 402. The initiation UI 402 of FIG. 4A shows a display of an example UI that can be used to initiate a transaction. The initiation UI 402 includes a calendar with a date icon 404 highlighting a travel date (Dec. 10, 2014) and a SALT icon 406. The user can highlight the date of the travel by click the date icon 404, and then click the SALT icon 406 to initiate the transaction. Turning to FIG. 4B, FIG. 4B is an illustration of an example result UI 400b according to an implementation. The UI 400b is in a configuration as a result UI 412 and indicates the result of the transaction of FIG. 4A. The result UI 412 includes a result icon 416. If the transaction is successfully executed, the result icon 416 can display a “SUCCESS” message. If the transaction fails, the result icon 416 can display a “FAIL” message.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, e.g., a central processing unit (CPU), an FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic disks, magneto optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media, and memory devices, including by way of example, semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and CD ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user, and a keyboard and a pointing device, e.g., a mouse, trackball, or trackpad, by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language-independent or -dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in Extensible Markup Language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products. Furthermore, while the operations depicted in the drawings may indicate start and/or end points for the operations, implementations of the methods described in the disclosure are not restricted to the particular start and/or end point as illustrated. Other implementations may start and/or end at different points of the operations.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A method for simplifying user interactions in a computer-aided transaction process, comprising:
receiving, from a client device, an initiation message to initiate a transaction process;
retrieving, at a server, transaction data from a database, wherein the transaction data is saved in the database during a previous transaction process;
executing, at the server, a transaction based on the transaction data;
obtaining a transaction result of the transaction; and
transmitting, to the client device, a response message that indicates the transaction result.

2. The method of claim 1, wherein the initiation message comprises temporal information, and wherein the execution of the transaction is further based on the temporal information.

3. The method of claim 1, wherein data of the transaction is saved in the database.

4. The method of claim 1, wherein the execution of the transaction is performed by a database command, where parameters of the database command comprise the transaction data.

5. The method of claim 1, wherein the initiation message is received from a mobile application on a mobile device.

6. A system for simplifying user interactions in a computer-aided transaction process, comprising:
a memory; and
at least one hardware processor interoperably coupled with the memory and configured to:
receive, from a client device, an initiation message to initiate a transaction process;
retrieve, at a server, transaction data from a database, wherein the transaction data is saved in the database during a previous transaction process;
execute, at the server, a transaction based on the transaction data;
obtain a transaction result of the transaction; and
transmit, to the client device, a response message that indicates the transaction result.

7. The system of claim 6, wherein the initiation message comprises temporal information, and wherein the execution of the transaction is further based on the temporal information.

8. The system of claim 6, wherein data of the transaction is saved in the database.

9. The system of claim 6, wherein the execution of the transaction is performed by a database command, where parameters of the database command comprise the transaction data.

10. The system of claim 6, wherein the initiation message is received from a mobile application on a mobile device.

11. A non-transitory, computer-readable medium storing computer-readable instructions for simplifying user interactions in a computer-aided transaction process, the instructions executable by a computer and configured to:
receive, from a client device, an initiation message to initiate a transaction process;
retrieve, at a server, transaction data from a database, wherein the transaction data is saved in the database during a previous transaction process;
execute, at the server, a transaction based on the transaction data;
obtain a transaction result of the transaction; and
transmit, to the client device, a response message that indicates the transaction result.

12. The non-transitory, computer-readable medium of claim 11, wherein the initiation message comprises temporal information, and wherein the execution of the transaction is further based on the temporal information.

13. The non-transitory, computer-readable medium of claim 11, wherein data of the transaction is saved in the database.

14. The non-transitory, computer-readable medium of claim 11, wherein the execution of the transaction is performed by a database command, where parameters of the database command comprise the transaction data.

15. The non-transitory, computer-readable medium of claim 11, wherein the initiation message is received from a mobile application on a mobile device.
